(19) United States
(12) Patent Application Publication
(10) Pub. No.: US 2009/0169900 A1
(43) Pub. Date: Jul. 2, 2009

(54) Ceramic Resistor Element or Sensor Element

(76) Inventors: Juergen Oberle, Sindelfingen (DE); Pia Mondal, Kochel Am See (DE); Thomas Brinz, Bissingen A.D. Teck (DE); Christof Rau, Shanghai (CN); Ilona Ullmann, Korntal-Muenchingen (DE); Heike Schluckwerder, Stuttgart (DE); Joerg Jockel, Gerlingen (DE); Sigrid Wagner, Stuttgart (DE); Jens Schneider, Loenberg (DE)

Correspondence Address: KENYON & KENYON LLP, ONE BROADWAY, NEW YORK, NY, 10004, US

(21) Appl. No.: 11/918,026

(22) PCT Filed: Mar. 24, 2006
(86) PCT No.: PCT/EP2006/061029

§ 371 Date: Jan. 15, 2009

(30) Foreign Application Priority Data
Apr. 5, 2005 (DE) 102005015569.3

(51) Int. Cl. B32B 15/00

(52) U.S. Cl. 428/450

(57) ABSTRACT

A ceramic resistor element or sensor element includes a ceramic substrate, which is exposable to a gas atmosphere containing carbon compounds, the ceramic substrate being provided with a coating. The coating includes copper, cerium and/or vanadium.

### FIELD OF THE INVENTION

The present invention relates to a ceramic resistor element or sensor element and its use.

### BACKGROUND INFORMATION

European Patent No. 0 412 428 describes that ceramic composite members can be produced from a siliconorganic polymer by suitable pyrolysis. However, if such composite members are used in resistor elements or sensor elements which are exposed to corrosive gas mixtures, such as exhaust gases of internal combustion engines, the ceramics have to be protected from corrosive influences. It is true that the usual ceramics based on, for instance, silicon nitride, silicon carbide or based on silicon oxycarbides, in contact with oxygen-containing gas atmospheres at elevated temperatures, form a self-protective, oxidic, vitreous layer on their surface; however, this layer is normally relatively thin, and does not reliably withstand, for instance, a durable stress through the action of exhaust gases of internal combustion engines.

If, for example, a ceramic resistor element is used as a heating element in sheathed-type glow plugs, there is the danger that soot deposits form on the glow plug (coking), when, for instance, combustion is not optimized. This coking can make it more difficult to remove the sheathed-type glow plug later. If the outer part of the ceramic sheathed-type glow plug is electrically conductive, the soot deposits can form a conducting path to the housing, whereby the sheathed-type glow plug can possibly no longer be operated correctly, or integrated sensor functions of the sheathed-type glow plug (such as ionic current measurements) are no longer ensured.

### SUMMARY

Example embodiments of the present invention provide a ceramic resistor element or sensor element that will withstand even long time applications at higher temperatures.

Example embodiments of the present invention provide a ceramic resistor element or sensor element which includes a ceramic substrate that is furnished with a coating. In order to design the ceramic resistor element or sensor element at least largely resistant to coking, the coating is developed so that a burn-off of deposited soot is made possible even at moderate temperatures, such as can prevail, for instance, during combustion processes in a combustion chamber. In this manner, it is effectively prevented that conductive structures form, going to a housing of the resistor element or sensor element. In addition, the inflammation temperature of the fuel can be catalytically reduced by the coating, so that a sheathed-type glow plug having the resistor element can be operated already at lower temperatures, and with that, its service life increases.

Advantageous refinements of the ceramic resistor element or sensor element according to the present invention are possible by using the measures described herein.

The coating may include copper, cerium, vanadium or mixtures of the same, the content of compounds of copper, cerium and vanadium amounting to more than 90 wt. %, for example. Furthermore, the coating can contain oxides of the elements zirconium, titanium, aluminum, yttrium, chromium and/or calcium. In this manner, coatings are achieved which are stable over long periods of time based on the added oxides, and which effectively catalyze the burn-off of deposited soot.

In addition, the coating can include up to 10 wt. % of the elements platinum, palladium and/or rhodium. In this manner, one can direct the coating to the specific field of application of the resistor element or sensor element.

It may be provided that the ceramic substrate of the resistor element or sensor element includes a ceramic produced by pyrolysis of an siliconorganic polymer, since the catalytic activity of the coating on the SiOC ceramic, resulting in the process, is particularly pronounced.

In an example embodiment of the present invention, an additional coating is provided between the coating and the ceramic substrate, which is implemented to be vitreous or partially crystalline. This coating is particularly used to protect the ceramic from corrosive effects, such as can occur in response to the action of exhaust gases of internal combustion engines.

The present resistor element or sensor element can be used particularly advantageously in sheathed-type glow plugs or for the determination of gases in exhaust gases of internal combustion engines.

Two exemplary embodiments of the present invention are depicted in the drawings and are elucidated in the following description.

### BRIEF DESCRIPTION OF THE DRAWINGS

FIG. 1a shows an exemplary embodiment of a sheathed-type glow plug in longitudinal section, which includes a resistor element.

FIG. 1b shows an exemplary embodiment of a sheathed-type glow plug in longitudinal section, which includes a resistor element.

### DETAILED DESCRIPTION

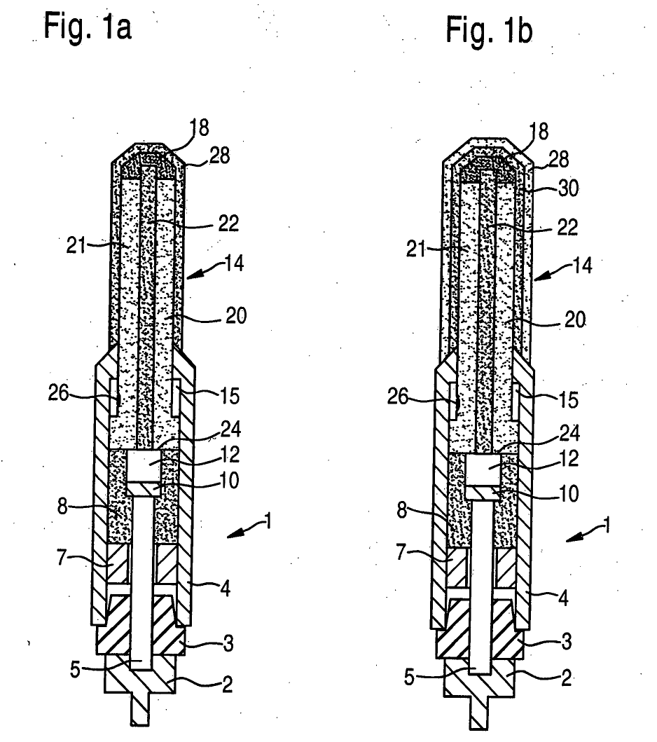

FIG. 1a shows a longitudinal section through an example embodiment of a sheathed-type glow plug 1 that includes an ceramic resistor element. At the end of the sheathed-type glow plug 1, that faces away from the combustion chamber, electrical contacting takes place via a circular connector 2, which is connected to a cylindrical lead 5, separated via a seal 3 from plug housing 4. Cylindrical lead 5 is fixed in position in plug housing 4 by a metal ring 7 and an electrically insulating, ceramic sleeve 8.

Cylindrical lead 5 is connected to a ceramic glow plug 14 via a contact pin 10 and a suitable contacting element 12, which may be formed as a contact spring, as an electrically conductive powder packing or as an electrically conductive tablet having an elastic spring component, e.g., made of graphite. Cylindrical lead 5 can also be unified with contact pin 10 in one component part. The interior of the sheathed-type glow plug is sealed from the combustion chamber by packing 15. Packing 15 is made of an electrically conductive carbon compound. However, packing 15 can also be made of metals, a mixture of carbon and metal, or a mixture of ceramic and metal.

The sheathed-type glow plug furthermore includes a resistor element in the form of a heating element 14 which is made of a ceramic heating layer 18 and ceramic lead layers 20 and 21, the two lead layers 20, 21 being connected by heating layer 18 and forming a conducting layer together with heating layer 18. Lead layers 20, 21 have an arbitrary shape, and heating layer 18 may also have an arbitrary shape. The conducting layer is preferably U-shaped. Lead layers 20, 21 are separated from each other by an insulating layer 22, which is also made of ceramic material. In the exemplary embodiment represented in FIG. 1, heating element 14 is designed to have lead layers 20 and 21, as well as heating layer 18, externally positioned on heating element 14. However, it is also possible for at least lead layers 20 and 21 to be situated inside the heating element 14 and to be covered by an external, ceramic insulating layer. Inside plug housing 4, ceramic heating element 14 is insulated from the remaining components of the sheathed-type glow plug 4, 8, 12, 15 by a glass layer.

The glass layer is interrupted at position 24, in order to produce the electrical contact between contacting element 12 and lead layer 20. An additional interruption of the glass layer at position 26 makes possible an electrical contact between lead layer 21 and plug housing 4.

The exemplary embodiment has heating layer 18 being placed at the tip of heating element 14. However, it is also possible for heating layer 18 to be placed at another position of the conducting layer. Heating layer 18 should be situated at the position where the greatest heating effect should be achieved.

The material of heating layer 18 is chosen so that the absolute electrical resistance of heating layer 18 is greater than the absolute electrical resistance of lead layers 20, 21.

In order to avoid cross-currents between the components of the conducting layer, the resistance of insulating layer 22 may be markedly greater than the resistance of heating layer 18 and lead layers 20, 21.

The specific resistance of insulating layer 22 may be at least 10 times greater than the specific resistance of heating layer 18 in the entire operating range of the sheathed-type glow plug.

In the above-described exemplary embodiments, the compositions of the insulating layer, the lead layers, and the heating layer are selected such that their thermal expansion coefficients and the shrinkages of the individual lead layers, heating layers, and insulating layers occurring during the sintering and pyrolysis processes are as equal as possible, so that no cracks are formed in the sheathed-element glow plug.

Heating layer 18 is made of an electrically conductive ceramic having a high electrical resistance. In this context, a ceramic resistor is involved based on an siliconorganic polymer provided with fillers, such as, for instance, a polysiloxane or a polysilsesquioxane. As the polysiloxane, a condensation cross-linked polyalkoxysiloxane or an addition cross-linking polysiloxane are used, for example, such as a methyl-phenyl-vinyl polysiloxane. Additional polymers such as polycarbosilane and polysilane can be added to the polysiloxanes used. These can be dissolved in a suitable solvent such as acetone or tetrahydrofuran, and have suitable fillers added. By the choice of, and the additive quantity of one or more suitable fillers the electrical resistance of the resulting ceramic can be specifically adjusted. Suitable fillers are, for example, molybdenum silicide, chromium disilicide, iron powder, silicon nitride, silicon powder, titanium silicide, cerium oxide, bismuth oxide, barium oxide, silicon carbide, boron carbide, boron nitride or graphite, as well as possibly even carbon nanotubes or aluminum oxide. Lead layers 20, 21 can be developed in a similar way, their electrical resistance being modifiable, for instance, by addition of electrically conductive fillers.

There is a danger, above all in the area heating layer 18, that an undesired coking of the ceramic surface of heating element 14 may occur, caused by the combustion processes taking their course in the combustion chamber. This danger exists particularly if the heating element is not activated or the combustion processes do not take place within the range of an optimal conversion. This coking can make it more difficult to remove the sheathed-type glow plug later. If the outer part of the ceramic heating element electrically conductive, the soot deposits can form a conducting path to the housing, whereby the heating element can possibly no longer be operated correctly, or integrated sensor functions of the sheathed-type glow plug (such as an ionic current measurement) are no longer ensured.

Therefore a coating 28 may be provided on the ceramic outer surfaces of the heating element that are exposed to the combustion chamber, which is catalytically active, and which provides for depositing soot particles to burn off at low temperatures. The main components of this coating are copper, cerium or vanadium, or mixtures of the same. In particular, a total content of compounds of copper, cerium and/or vanadium of more than 85 wt. %, especially more than 90 wt. %, may be provided in this connection. The named elements copper, cerium and vanadium may be contained in coating 28 as oxides, cerium being present, e.g., as CeO₂ and/or Ce₂O₃.

An additional advantage of catalytic coating 28 may be seen in that the inflammation temperature of the fuel combusted in the combustion chamber is possibly reduced, caused by the catalytic function of coating 30, so that the sheathed-type glow plug can be operated at lower temperatures, and its service life thus increases.

Coating 28 can additionally contain up to 20 wt. %, especially up to 10 wt. % of the platinum metals platinum, palladium, rhodium and/or iridium.

Moreover, coating 28 can also contain high-melting metal oxides of, for instance, the elements Zr, Ti, Al, Y, Cr or Ca, as well as mixtures of the same, in order to counteract a possible aging of the catalytically active components of the coating.

The layer thickness of coating 28 may amount to up to 50 μm, especially 0.5 to 10 μm. Coating 28, especially in the composition described, develops its catalytic effect above all on ceramic substrates that have been produced based on siliconorganic polymers.

Coating 28 can be produced on the ceramic substrate by applying a dispersion or solution of the catalytically active substances, for instance, using dip coating, printing on, rolling on, impregnating or by air pressure atomization or ultrasound atomization onto the surface of the pin, and by subsequently submitting the latter to heat treatment in air at temperatures of more than 500° C., especially at 800 to 1300° C. at a treatment time of 0.25 to 12 h.

FIG. 1b shows an additional sheathed-type glow plug containing a ceramic resistor element. In this context, identical reference numerals designate the same components as in FIG. 1a.

The sheathed-type glow plug shown in FIG. 1b includes a resistor element in the form of heating element 14 which has an additional coating 30 between coating 28 and the ceramic substrate in the form of ceramic layers 18, 20, 21. Additional coating 30 is formed by a glass layer or a composite layer which is designed to be gas-tight, alkali-resistant and stable at high temperature, for example. Glass layer or composite layer 30 contains one or more of the following oxides: celsian, mullite, silicon dioxide, aluminum oxide and calcium oxide. In addition, the layer can have proportions of sodium or boron. The layer thickness of additional coating 30 may amount to up to 20 μm, especially 0.5 to 10 μm. The application of additional coating 30 to a sheathed-type glow plug may take place in a similar manner as the production of coating 28.

Coatings 28, 30 can cover heating element 14 over part of its surface or over its full surface. It can be provided, in this context, that additional coating 30 covers heating element 14 over a greater surface range than coating 28. Thus, additional coating 30 can, for instance, cover heating element 14 substantially over its whole surface, while, by contrast, coating 28 is provided only in the area of heating layer 18.

If coated sheathed-type glow plugs are submitted to a long-term test, it shows that sheathed-type glow plugs having a coating 28 in the area of heating layer 18 which contained elements such as Ir, Pt, Y, Ti, Zr, Cr, W, Mn, Fe, Co, Ni, Zn, Ga and others, without the addition of copper, cerium or vanadium, only showed a burn-off of deposited soot, that is worth mentioning, at temperatures above 585° C., whereas copper-containing coatings 28 already had the effect of a noticeable burn-off of the soot coating at 515° C.; in the case of vanadium-containing coatings 28 already at temperatures of 450° C., and for copper as well as vanadium-containing coatings 28 already at temperatures between 450° C. and 515° C.

The ceramic resistor element is not only suitable as a heating element for sheathed-type glow plugs in Diesel engines, engine-independent heaters and additional heaters, but also for heating devices of flame glow plugs or ceramic gas sensors, as well as for high temperature applications. In particular, ceramic outer surfaces of electrochemical sensor elements, for the determination of gases in gas mixtures, can also be provided with the coatings described.

1-13. (canceled)

14. A device, comprising:
a ceramic substrate, which is exposable to a gas atmosphere including carbon compounds, the ceramic substrate being provided with a coating including at least one of (a) copper, (b) cerium and (c) vanadium, the device arranged as at least one of (a) a ceramic resistor element and (b) a sensor element.

15. The device according to claim 14, wherein the coating is formed up to more than 90 wt. % by compounds of the at least one of (a) copper, (b) cerium and (c) vanadium.

16. The device according to claim 14, wherein the coating includes oxides at least one of (a) zirconium, (b) titanium, (c) aluminum, (d) yttrium, (e) chromium and (f) calcium.

17. The device according to claim 14, wherein the coating includes up to 10 wt. % of at least one of (a) platinum, (b) palladium and (c) rhodium.

18. The device according to claim 14, wherein the coating includes cerium in the form of at least one of (a) CeO₂ and (b) Ce₂O₃.

19. The device according to claim 14, wherein the coating has a layer thickness of 0.5 to 50 μm.

20. The device according to claim 14, wherein the substrate includes a ceramic produced by pyrolysis of an siliconorganic polymer.

21. The device according to claim 14, wherein the substrate includes silicon nitride.

22. The device according to claim 14, wherein the substrate includes as filler at least one of (a) silicon carbide, (b) molybdenum disilicide, (c) chromium disilicide, (d) molybdenum carbide, (e) iron, (f) silicon, (g) aluminum oxide and (h) graphite.

23. The device according to claim 14, wherein an additional coating is provided, between the coating and the ceramic substrate, which is at least one of (a) vitreous and (b) partially crystalline.

24. The device according to claim 23, wherein the additional coating includes at least one of (a) mullite, (b) celsian, (c) silicon dioxide, (d) aluminum dioxide and (e) calcium oxide.

25. The device according to claim 14, wherein the device is arranged as a sheathed-type glow plug.

26. The device according to claim 14, wherein the device is configured to determine gases in exhaust gases of internal combustion engines.
